(19) United States
(12) Patent Application Publication
(10) Pub. No.: US 2025/0125083 A1
(43) Pub. Date: Apr. 17, 2025

(54) INDUCTOR COMPONENT

(71) Applicant: Murata Manufacturing Co., Ltd., Kyoto-fu (JP)

(72) Inventor: Seiya KIKUCHI, Nagaokakyo-shi (JP)

(73) Assignee: Murata Manufacturing Co., Ltd., Kyoto-fu (JP)

(21) Appl. No.: 18/913,383

(22) Filed: Oct. 11, 2024

(30) Foreign Application Priority Data
Oct. 17, 2023 (JP) 2023-178823

(51) Int. Cl. H01F 27/28; H01F 27/29

(52) U.S. Cl. CPC H01F 27/2828; H01F 27/292

(57) ABSTRACT

An inductor component including an element body, a coil in the element body, and first and second outer electrodes that are at the element body and are electrically coupled to the coil. The coil includes a winding portion spirally wound along an axis direction. The coil includes the winding portion, and first and second extended wirings that couple one end and the other end of the winding portion to the first and second outer electrodes, respectively, at least one of the first and second outer electrodes includes an embedded portion embedded in the element body, at least one of the first and second extended wirings includes a coupling portion coupled to the winding portion and a curved portion curved from the coupling portion toward the embedded portion. In a view from the axial direction, the curved portion has a recessed shape.

### CROSS-REFERENCE TO RELATED APPLICATION

This application claims benefit of priority to Japanese Patent Application No. 2023-178823, filed Oct. 17, 2023, the entire content of which is incorporated herein by reference.

### BACKGROUND

### Technical Field

The present disclosure relates to an inductor component.

### Background Art

A conventional inductor component is disclosed in Japanese Unexamined Patent Application Publication No. 2017-11044. The inductor component includes an element body, a coil provided in the element body, and a first outer electrode and a second outer electrode that are provided at the element body and that are electrically coupled to the coil. The coil includes a winding portion, and first and second extended wirings coupling one end and the other end of the winding portion to the first outer electrode and the second outer electrode, respectively.

### SUMMARY

In conventional inductor components, reduction in firing residual stress generated at an interface between an outer electrode and an element body is being attempted as an anti-cracking measure. In order to reduce the firing residual stress, in the conventional inductor components, the volume of the outer electrode is reduced and the wiring width of the extended wiring is reduced. However, in the conventional inductor components, a current concentrates on a contact surface where the extended wiring and the outer electrode are in contact with each other, and the contact surface generates heat in some cases.

Accordingly, the present disclosure provides an inductor component that suppresses heat generation at a contact surface between a coil and an outer electrode.

An inductor component according to an aspect of the present disclosure includes an element body, a coil provided in the element body, and a first outer electrode and a second outer electrode that are provided at the element body and that are electrically coupled to the coil. The coil includes a winding portion spirally wound along an axis direction. Also, the coil includes the winding portion, and a first extended wiring and a second extended wiring that couple one end and the other end of the winding portion to the first outer electrode and the second outer electrode, respectively. At least one of the first outer electrode and the second outer electrode includes an embedded portion embedded in the element body. At least one of the first extended wiring and the second extended wiring includes a coupling portion coupled to the winding portion and a curved portion curved from the coupling portion toward the embedded portion. Also, in a view in the axis direction, the curved portion has a recessed shape, and a length dimension L1 of a contact surface between the embedded portion and the extended wiring is larger than a wiring width W1 of the coupling portion, and the length dimension L1 is larger than a height dimension D1 of the embedded portion in a direction perpendicular to the contact surface.

The contact surface between the curved portion and the embedded portion has the length dimension L1 longer than the wiring width W1 of the coupling portion, which increases the contact surface between the curved portion and the embedded portion and reduces an amount of a current flowing per unit area. As a result, heat generated at the contact surface between the curved portion and the embedded portion can be dissipated, and a temperature rise at the contact surface can be suppressed.

According to the aspect of the present disclosure, the inductor component can suppress heat generation at the contact surface between the coil and the outer electrode.

### BRIEF DESCRIPTION OF THE DRAWINGS

FIG. 1 is a perspective view showing a first embodiment of an inductor component;

FIG. 2 is a perspective front view of the first embodiment as viewed from a first side surface side;

FIG. 3 is an exploded view of the first embodiment;

FIG. 4 is a perspective front view of a second embodiment as viewed from the first side surface side;

FIG. 5 is an exploded view of the second embodiment;

FIG. 6 is a perspective front view of a third embodiment as viewed from the first side surface side;

FIG. 7 is an exploded view of the third embodiment;

FIG. 8 is a perspective front view of a fourth embodiment as viewed from a top surface side;

FIG. 9A is an exploded view of the fourth embodiment;

FIG. 9B is an exploded view of the fourth embodiment; and

FIG. 9C is an exploded view of the fourth embodiment.

### DETAILED DESCRIPTION

Hereinafter, an inductor component according to an aspect of the present disclosure will be described in detail with reference to the embodiments shown in the drawings. Note that the drawings include partially schematic drawings and do not reflect actual dimensions and ratios in some cases.

### First Embodiment

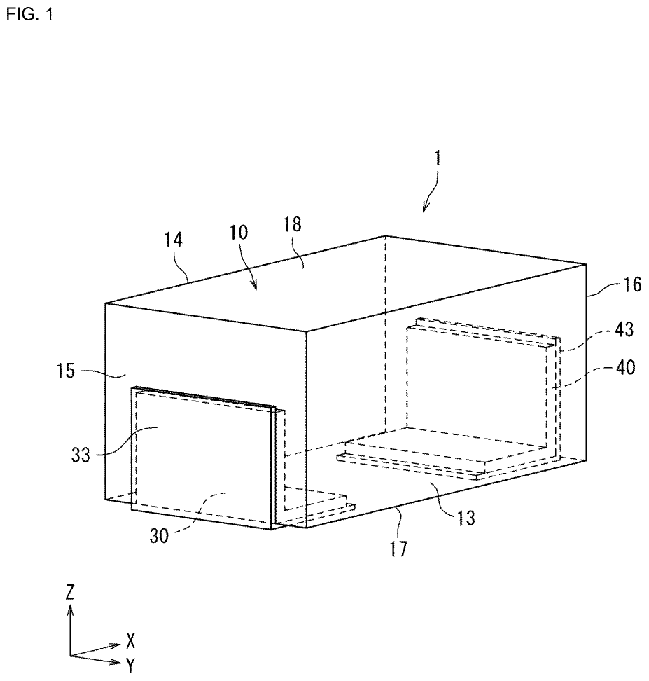

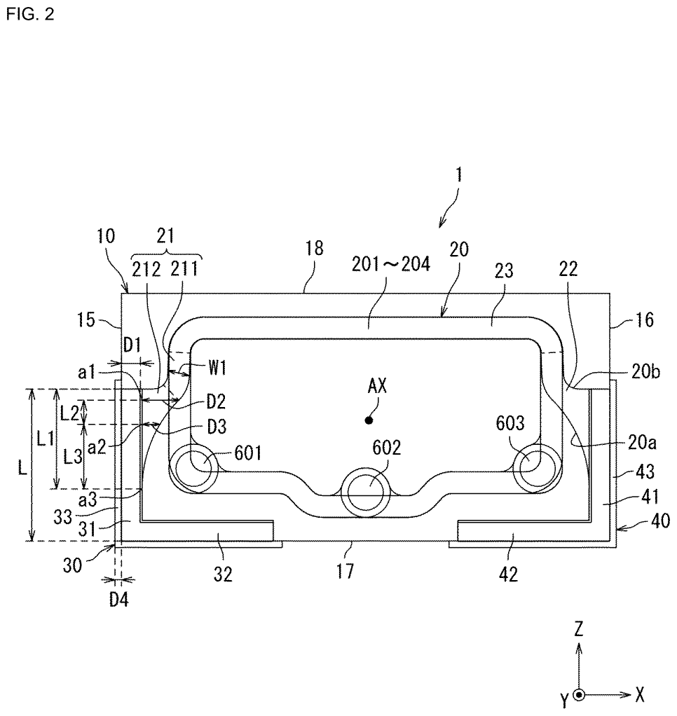

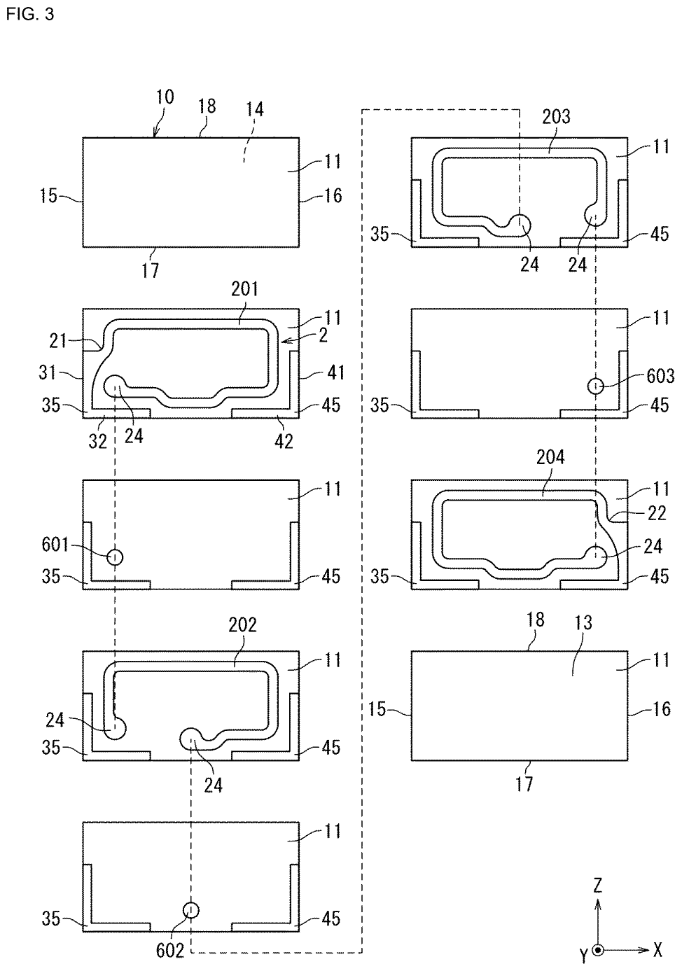

FIG. 1 is a perspective view showing a first embodiment of an inductor component. FIG. 2 is a perspective front view of the inductor component as viewed from a first side surface side. FIG. 3 is an exploded view of the inductor component.

As shown in FIG. 1 to FIG. 3, an inductor component 1 includes an element body 10, a coil 20 provided on the element body 10, and a first outer electrode 30 and a second outer electrode 40 that are provided at the element body 10 and that are electrically coupled to the coil 20. Note that in FIG. 2, for convenience, the element body and the coil are illustrated as transparent for easy understanding of the structure, but may be translucently or opaquely formed.

The inductor component 1 is electrically coupled to wirings of a circuit board (not shown) through the first and second outer electrodes 30 and 40. The inductor component 1 is used as, for example, an impedance matching coil (matching coil) of a radio frequency circuit, and is used in electronic devices such as personal computers, DVD players, digital cameras, TVs, mobile phones, car electronics, and medical/industrial machines. However, the use of the inductor component 1 is not limited thereto, and the inductor component 1 can also be used in, for example, a tuning circuit, a filter circuit, a rectifying and smoothing circuit, or the like.

The element body 10 is formed in a substantially rectangular parallelepiped shape. The element body 10 includes a first side surface 13 and a second side surface 14 that are opposed to each other, a first end surface 15 and a second end surface 16 that are opposed to each other, a bottom surface 17 coupled between the first side surface 13 and the second side surface 14 and between the first end surface 15 and the second end surface 16, and a top surface 18 opposed to the bottom surface 17. That is, an outer surface of the element body 10 is constituted by the first side surface 13, the second side surface 14, the first end surface 15, the second end surface 16, the bottom surface 17, and the top surface 18.

Note that as shown in FIG. 1, an X direction is a direction that is orthogonal to the first end surface 15 and the second end surface 16 and that is directed from the first end surface 15 toward the second end surface 16. A Y direction is a direction that is orthogonal to the first side surface 13 and the second side surface 14 and that is directed from the second side surface 14 toward the first side surface 13. A Z direction is a direction that is orthogonal to the bottom surface 17 and the top surface 18 and that is directed from the bottom surface 17 toward the top surface 18. The X direction is also referred to as a length direction of the element body 10, the Y direction is also referred to as a width direction of the element body 10, and the Z direction is also referred to as a height direction of the element body 10. The X direction, the Y direction, and the Z direction are directions orthogonal to each other, and constitute a left-handed system when arranged in the order of X, Y, and Z.

As shown in FIG. 3, the element body 10 is configured by laminating a plurality of insulating layers 11. Specifically, the element body 10 is constituted by laminating the plurality of insulating layers 11 in a direction from the second side surface 14 to the first side surface 13. Note that the number of the insulating layers 11 is not limited to the number shown in FIG. 3. Additionally, in the present application, the term “laminated” is not limited to the direction in which the layers are laminated during manufacturing, but includes the opposite direction. Note that in FIG. 3, the layers are laminated in order in a direction from upper left to lower right. In the other exploded views, the layers are similarly laminated in order.

The insulating layer 11 is made of a magnetic material or a non-magnetic material. Examples of the magnetic material include ferrite, and examples of the non-magnetic material include glass such as borosilicate glass, alumina, and resin. The plurality of insulating layers 11 are laminated in the Y direction. Each insulating layer 11 is a layer spreading in an XZ plane orthogonal to the laminating direction of the Y direction. A thickness of each insulating layer 11 is not particularly limited. For example, the insulating layers 11 have the same thickness. Note that among the plurality of insulating layers 11, an interface between two adjacent insulating layers 11 is not clear in some cases due to firing or the like. Alternatively, the thicknesses of the insulating layers 11 may be different from each other. For example, the insulating layer 11 corresponding to the second side surface 14 and the insulating layer 11 corresponding to the first side surface 13 may be thicker or thinner than the other insulating layers 11.

The first outer electrode 30 has an L shape formed from the first end surface 15 to the bottom surface 17. The first outer electrode 30 includes a first embedded portion 31 that is provided in the element body 10 and that spreads along the first end surface 15, a second embedded portion 32 that is provided in the element body 10, that is coupled to the first embedded portion 31, and that spreads along the bottom surface 17, and a first plating layer 33 that is positioned on the surface of the element body 10 and that is formed on surfaces of the first and second embedded portions 31 and 32.

The first and second embedded portions 31 and 32 may be made of, for example, an electrically conductive material such as Ag, Cu, or Au, and glass particles, or may be made of the same material as that of the coil 20.

The first plating layer 33 is provided on the first and second embedded portions 31 and 32, and has an L shape. The first plating layer 33 rises from the surface of the element body 10. Note that the first plating layer 33 may be partially embedded in the element body 10 or may be entirely embedded in the element body 10.

The first plating layer 33 is formed by, for example, Ni, Sn, Au, or Cu plating, or the like. For example, a Ni plating layer is provided on the first and second embedded portions 31 and 32, and a Sn plating layer is provided on the Ni plating layer. As shown in FIG. 1 and FIG. 2, a height of the first plating layer 33 in the Z-axis direction is larger than a height of the first embedded portion 31 in the Z-axis direction at the first end surface 15. A length of the first plating layer 33 in the X-axis direction is larger than a length of the second embedded portion 32 in the X-axis direction at the bottom surface 17. Note that the height of the first plating layer 33 in the Z-axis direction may be smaller than or equal to the height of the first embedded portion 31 in the Z-axis direction. The length of the first plating layer 33 in the X-axis direction may be smaller than or equal to the length of the second embedded portion 32 in the X-axis direction.

The second outer electrode 40 has an L shape formed from the second end surface 16 to the bottom surface 17. The second outer electrode 40 includes a first embedded portion 41 that is provided in the element body 10 and that spreads along the second end surface 16, a second embedded portion 42 that is provided in the element body 10, that is coupled to the first embedded portion 41, and that spreads along the bottom surface 17, and a second plating layer 43 that is positioned on the surface of the element body 10 and that is formed on surfaces of the first and second embedded portions 41 and 42.

The first and second embedded portions 41 and 42 may be made of, for example, an electrically conductive material such as Ag, Cu, or Au, and glass particles, or may be made of the same material as that of the coil 20.

The first plating layer 43 is provided on the first and second embedded portions 41 and 42, and has an L shape. The first plating layer 43 rises from the surface of the element body 10. Note that the first plating layer 43 may be partially embedded in the element body 10 or may be entirely embedded in the element body 10. Note that the plating layer is a layer including a plating film.

The first plating layer 43 is formed by, for example, Ni, Sn, Au, or Cu plating, or the like. For example, a Ni plating layer is provided on the first and second embedded portions 41 and 42, and a Sn plating layer is provided on the Ni plating layer. As shown in FIG. 1 and FIG. 2, a height of the second plating layer 43 in the Z-axis direction is larger than a height of the first embedded portion 41 in the Z-axis direction at the second end surface 16. A length of the second plating layer 43 in the X-axis direction is larger than a length of the second embedded portion 42 in the X-axis direction at the bottom surface 17. Note that the height of the second plating layer 43 in the Z-axis direction may be smaller than or equal to the height of the first embedded portion 41 in the Z-axis direction. The length of the second plating layer 43 in the X-axis direction may be smaller than or equal to the length of the second embedded portion 42 in the X-axis direction.

As shown in FIG. 3, the first and second embedded portions 31 and 32 have a configuration in which a plurality of first outer electrode conductor layers 35 embedded in the element body 10 are laminated in surface contact with each other. The first and second embedded portions 41 and 42 have a configuration in which a plurality of second outer electrode conductor layers 45 embedded in the element body 10 are laminated in surface contact with each other. Each first outer electrode conductor layer 35 extends along the first end surface 15 and the bottom surface 17, and each second outer electrode conductor layer 45 extends along the second end surface 16 and the bottom surface 17. Providing the embedded portion 31, 32, 41, and 42 in the element body 10 allows the inductor component 1 to be miniaturized. In addition, the coil 20 and the embedded portions 31, 32, 41, and 42 can be formed in the same process, and variations in positional relationship between the coil 20 and the first and second outer electrodes 30 and 40 are reduced, so that variations in electrical characteristics of the inductor component 1 can be reduced. Note that a part of each of the outer electrode conductor layers 35 and 45 may be embedded in the element body 10, and the other part may be formed on the outer surface of the element body 10. The entire outer electrode conductor layers 35 and 45 may be formed on the outer surface of the element body 10. Further, in FIG. 3, the first and second plating layers 33 and 43 are not shown.

The coil 20 includes an outer peripheral surface 20a on an inner diameter side, which is on an axis AX side, and an outer peripheral surface 20b on an outer diameter side opposite to the inner diameter side. The coil 20 has a helical structure in which the axis AX thereof is parallel to the bottom surface 17 of the element body 10 and the coil 20 is wound while advancing along the axis so as to cross the first side surface 13 and the second side surface 14 of the element body 10. The axis of the coil is parallel to the Y direction. The coil 20 contains Ag. The coil 20 may contain an electrically conductive material (for example, Cu, Au, or the like) other than Ag, or glass.

The coil 20 is formed in a substantially rectangular shape when viewed from the axis AX direction, but is not limited to this shape. The shape of the coil 20 may be, for example, a circular shape, an elliptical shape, a rectangular shape, or another polygonal shape. The axis direction of the coil 20 refers to a direction parallel to a spiral central axis around which the coil 20 is wound. The axis direction of the coil 20 and the laminating direction of the insulating layers 11 are the same direction. The term “parallel” in the present application is not limited to a strict parallel relationship. In other words, the term “parallel” also includes a substantially parallel relationship in consideration of a realistic range of variations.

The coil 20 includes a winding portion 23, a first extended wiring 21 positioned between a first end of the winding portion 23 and the first outer electrode 30, and a second extended wiring 22 positioned between a second end of the winding portion 23 and the second outer electrode 40. In the present embodiment, the winding portion 23 and the first and second extended wirings 21 and 22 are integrated, and no clear boundary exists therebetween. However, the present disclosure is not limited thereto, and the winding portion and the extended wirings may be formed of different materials or by different methods, and thus, boundaries may exist therebetween.

The winding portion 23 is wound in a spiral shape along the axis AX. That is, the winding portion 23 refers to a portion wound in a spiral shape in which turns of the coil 20 overlap each other when viewed from the direction parallel to the axis AX. The first and second extended wirings 21 and 22 refer to portions deviated from the overlapping portion. The winding portion 23 is formed in a substantially rectangular shape when viewed from the axis AX direction, but is not limited to this shape. The shape of the winding portion 23 may be, for example, a circular shape, an elliptical shape, or another polygonal shape.

As shown in FIG. 2 and FIG. 3, the winding portion 23 includes a plurality of coil wiring layers 201, 202, 203, and 204 each of which is wound along a plane and via wirings 601, 602, and 603 coupling the plurality of coil wiring layers 201, 202, 203, and 204. Note that the number of coil wiring layers and the number of via wirings are not limited to the above.

Each of the first to fourth coil wiring layers 201, 202, 203, and 204 is sandwiched between the insulating layers 11, and the first to fourth coil wiring layers 201, 202, 203, and 204 are laminated in order along the axis AX direction (Y direction). That is, the laminating direction of the insulating layers 11 is the same as the axis AX direction.

Each of the first to fourth coil wiring layers 201, 202, 203, and 204 is formed by being wound on the main surface (XZ plane) of a respective one of the insulating layers 11 orthogonal to the axis AX direction. The number of turns of each of the coil wiring layers 201, 202, 203, and 204 is less than one but may be one or more.

Pad portions 24 coupled to the via wirings are individually provided at one end portion of the first coil wiring layer 201 and one end portion of the fourth coil wiring layer 204 and at both end portions of the second coil wiring layer 202 and both end portions of the third coil wiring layer 203. The pad portions 24 protrude more inward from the coil 20 relative to the first to fourth coil wiring layers 201, 202, 203, and 204 when viewed from the axis AX direction. Note that as shown in FIG. 3, a part of each of the pad portions 24 does not protrude outward from the coil 20 relative to a respective one of the first to fourth coil wiring layers 201, 202, 203, and 204, when viewed from the axis AX direction, and each of the pad portions 24 and the respective one of the first to fourth coil wiring layers 201, 202, 203, and 204 are substantially flush with each other at an outer tip end of the coil 20. Note that each pad portion 24 may protrude outward or may protrude both inward and outward.

Each pad portion 24 has a circular shape. A diameter of each pad portion 24 is larger than a wiring width of the respective one of the first to fourth coil wiring layers 201, 202, 203, and 204. The wiring widths of the first to fourth coil wiring layers 201, 202, 203, and 204 are dimensions in the width direction orthogonal to a spreading direction of the first to fourth coil wiring layers 201, 202, 203, and 204 when viewed from the axis AX direction. Each wiring width is an average value of the wiring width of the coil 20.

The first to third via wirings 601, 602, and 603 penetrate the insulating layers 11 in the thickness direction (Y direction). Moreover, the coil wiring layers adjacent to each other in the laminating direction are electrically coupled in series with the corresponding via wiring interposed therebetween. Specifically, the first coil wiring layer 201 and the second coil wiring layer 202 are electrically coupled to each other with the first via wiring 601 interposed therebetween. The second coil wiring layer 202 and the third coil wiring layer 203 are electrically coupled to each other with the second via wiring 602 interposed therebetween. The third coil wiring layer 203 and the fourth coil wiring layer 204 are electrically coupled to each other with the third via wiring 603 interposed therebetween.

In this way, the plurality of coil wiring layers 201, 202, 203, and 204 are electrically coupled in series to each other to form a spiral. However, all the coil wiring layers do not need to be electrically coupled to each other in series, and some or all of the coil wiring layers may be electrically coupled to each other in parallel.

The first extended wiring 21 is coupled to the first coil wiring layer 201 at one end portion thereof and is coupled to the first outer electrode 30 at the other end portion thereof. The second extended wiring 22 is coupled to the fourth coil wiring layer 204 at one end portion thereof and is coupled to the second outer electrode 40 at the other end portion thereof.

The first extended wiring 21 includes a first coupling portion 211 coupled to the winding portion 23, and a first curved portion 212 including a curved surface curved from the first coupling portion 211 toward the first embedded portion 31 side. The curved surface of the first curved portion 212 has a recessed shape, and a length dimension L1 of a first contact surface of the first curved portion 212 between the first embedded portion 31 and the first extended wiring 21 is larger than a wiring width W1 of the first coupling portion 211. In a cross section that is orthogonal to the first end surface 15 and the top surface 18 and that crosses the first curved portion 212, the length dimension L1 is larger than a height dimension D1 of the first embedded portion 31 in a direction perpendicular to the first contact surface. Note that the recessed shape is a shape recessed toward the first curved portion 212 side, and is, for example, a shape having a fillet or a part of an elliptical shape. In other words, the first curved portion 212 has a recessed shape from the first curved portion 212 toward the element body 10 side. Additionally, the wiring width W1 of the first coupling portion 211 is the same as the wiring width of the winding portion 23. In addition, in the present embodiment, the length dimension refers to the maximum value of a dimension in a lateral direction (Z direction) of a first bonding surface between the first embedded portion 31 and the first curved portion 212. The wiring width W1 of the coupling portion means a width of the wiring in the first coupling portion 211. Note that in the present specification, a portion of the first extended wiring 21 that is in contact with the first embedded portion 31 and that includes a curved surface having a recessed shape is referred to as the first curved portion 212, and a portion of the first extended wiring 21 that couples the first curved portion and the winding portion 23 and that has a certain wiring width W1 is referred to as the first coupling portion 211. Further, a length of the first coupling portion 211 along an extending direction is not particularly limited, and may be shorter than the wiring width W1 or longer than the wiring width W1.

In conventional inductor components, attempts have been made to reduce wiring widths of extended wirings and reduce height dimensions of outer electrodes. However, in the above configuration, a current density per unit area of a plating layer may be increased. In such a case, when the plating layer includes, for example, a Ni plating layer and a Sn plating layer, electrochemical migration occurs in the plating layer, and Ni diffuses into the Sn plating layer. As a result, the Ni plating layer disappears, the Sn plating layer and the embedded portion come into contact with each other, and atoms (for example, Ag) contained in the embedded portion diffuse into the Sn plating layer (Ag erosion by Sn). In such a case, the current becomes more difficult to flow, and a direct current resistance (Rdc) increases, resulting in generating heat, and increasing a risk of breaking coupling.

In contrast, in the present disclosure, the first contact surface between the first curved portion 212 and the first embedded portion 31 has the length dimension L1 that is larger than the wiring width W1 of the first coupling portion 211 and that is larger than the height dimension D1 of the first embedded portion 31. Thus, even if the height dimension D1 of the first embedded portion 31 is small, an amount of a current flowing per unit area can be reduced by increasing an area of the first contact surface between the first curved portion 212 and the first embedded portion 31, and generated heat can be dissipated at the first extended wiring 21. As a result, a temperature rise at the first contact surface can be suppressed, and electrochemical migration can be suppressed. For example, when the first plating layer 33 includes a Ni plating layer and a Sn plating layer, even when the height dimension D1 of the first embedded portion 31 is reduced, disappearance of the Ni plating layer can be suppressed. As a result, the Sn plating layer and the first embedded portion 31 can be prevented from coming into contact with each other, and diffusion of atoms contained in the first embedded portion 31 can be reduced.

In addition, reducing the wiring width W1 can reduce a portion where the first extended wiring 21 and the winding portion 23 overlap each other in a view from the extending direction of the axis AX, and thus, magnetic flux is not blocked, so that an inductance can be efficiently obtained. Furthermore, reducing the wiring width W1 and increasing the length dimension L1 can suppress a residual stress generated at the first extended wiring 21 as low as possible, which allows the occurrence of cracks to be suppressed. Note that in the present embodiment, the height dimension refers to a dimension in a direction (height direction) perpendicular to the first bonding surface when viewed from the first bonding surface between the first embedded portion 31 and the first curved portion 212. In addition, when the first bonding surface is not clearly provided, a portion where the plurality of outer electrode conductor layers 35 overlap each other when viewed from the direction parallel to the axis AX may be defined as the first embedded portion 31, and a boundary between the first embedded portion 31 and the first curved portion 212 may be defined as the first bonding surface.

Preferably, a surface of the first curved portion 212 is smoothly curved. That is, the first curved portion 212 does not have a corner portion. When the first curved portion 212 has a corner portion, a current concentrates on the corner portion, which means that a Q value for radio frequency cannot be obtained. In contrast, when the first curved portion 212 has a curved shape and does not have a corner portion on which a current concentrates, and thus a Q value for radio frequency can be obtained.

Preferably, in projection onto the second side surface 14 along the axis AX direction, in the first extended wiring 21, a maximum height dimension D2 of the first curved portion 212 in a direction parallel to the height dimension D1 of the embedded portion is larger than the height dimension D1 of the first embedded portion 31. With the above configuration, a surface area of the first extended wiring 21 increases, and generated heat can be further dissipated at the first extended wiring 21.

Preferably, in a cross section orthogonal to the first end surface 15 and the top surface 18, an increase rate in the wiring width of the first curved portion 212 increases from a contact surface between the first coupling portion 211 and the first curved portion 212 toward a contact surface between the first embedded portion 31 and the first curved portion 212. That is, the wiring width of the first curved portion 212 is larger than the wiring width W1 of the first coupling portion 211, and the first curved portion 212 has the length dimension L1 that is the largest at the first contact surface between the first curved portion 212 and the first embedded portion 31. With the above configuration, an area of the first contact surface between the first curved portion 212 and the first embedded portion 31 is increased, and an amount of a current flowing per unit area can be reduced. Note that the increase rate means that an increase amount in wiring width of the first curved portion 212 per unit length along the extending direction increases as the first curved portion 212 comes close to the first embedded portion 31. Additionally, in measuring the wiring width of the first curved portion 212, when a part of the wiring width overlaps the first embedded portion 31, the part is not included in the wiring width.

Preferably, in projection onto the second side surface 14 along the axis AX direction, a first contact point a1 having the maximum height dimension D2 of the first curved portion 212, a second contact point a2 having a height dimension D3 that is half of the maximum height dimension D2 of the first curved portion 212, and a third contact point a3 at which the surface of the first curved portion 212 and the first embedded portion 31 are in contact with each other are provided in this order on the first contact surface between the first embedded portion 31 and the first curved portion 212. That is, the first contact point a1, the second contact point a2, and the third contact point a3 are aligned in a reverse Z direction. At this time, a length dimension L3 along the contact surface between the first embedded portion 31 and the first curved portion 212 from the second contact point a2 to the third contact point a3 is larger than a length dimension L2 along the contact surface between the first embedded portion 31 and the first curved portion 212 from the first contact point a1 to the second contact point a2. With the above configuration, the area of the first contact surface is increased, which can reduce an amount of a current flowing per unit area, resulting in suppressing an increase in temperature of the first contact surface. Note that the first contact point a1, the second contact point a2, and the third contact point a3 may be aligned in the Z direction.

Preferably, the length dimension L1 of the first contact surface between the first curved portion 212 and the first embedded portion 31 is equal to or more than 10 μm. With the above configuration, the area of the first contact surface is increased, which allows an amount of a current flowing per unit area to be reduced. In addition, the area of the surface of the first curved portion 212 is increased, and thus heat generated at the first curved portion 212 can be dissipated. An upper limit of the length dimension L1 is not particularly limited, but may be 80 μm when the length dimension L of the first embedded portion 31 is 121 μm, for example. Additionally, the upper limit of the length dimension L1 is not particularly limited, and may be, for example, equal to or less than ⅔ of the length dimension L of the first embedded portion 31.

Preferably, in projection onto the second side surface 14 along the axis AX direction, a ratio of the length dimension L1 of the first contact surface relative to the length dimension L of the first embedded portion 31 is equal to or more than 1/8 and equal to or less than 2/3 (i.e., from 1/8 to 2/3). Note that the length dimension L refers to a length of a portion of the first embedded portion 31 exposed to the surface of the element body 10 in a view from the axis AX direction, and the length dimension L1 refers to a length of the contact surface between the first embedded portion 31 and the first curved portion 212 in the view from the axis AX direction. Setting the above-described ratio to be equal to or more than 1/8 increases the area of the first contact surface, resulting in reducing an amount of a current flowing per unit area. Setting the above-described ratio to be equal to or less than 2/3 appropriately keeps a distance between the winding portion 23 and the first curved portion 212, which can suppress a stray capacitance. In addition, the first curved portion 212 and the winding portion 23 can be separated from each other, and the risk of a short circuit between the first curved portion 212 and the winding portion 23 can be reduced. Further, the residual stress can be appropriately suppressed, and the occurrence of cracks between the first embedded portion 31 and the first curved portion 212 can be suppressed. When the above-described ratio is too small, the risk of breaking coupling due to electrochemical migration increases. When the above-described ratio is too large, a distance between the winding portion 23 and the first extended wiring 21 is reduced, which causes the stray capacitance to increase. In addition, the first curved portion 212 and the winding portion 23 are close to each other, and thus, the risk of a short circuit increases. Further, since the residual stress increases, the risk of cracking increases. Note that the term “exposed” means exposure to the surface of the element body 10, and the exposure may be complete exposure to the outside without overlapping another layer or portion, or exposure where another layer or portion overlies the exposed portion.

Preferably, at least one of the first outer electrode 30 and the second outer electrode 40 further includes the first plating layer 33 covering at least a part of the portion of the first embedded portion 31 exposed on the surface of the element body 10, and the first plating layer 33 contains metal atoms different from those of the first embedded portion 31 and the first extended wiring 21. Specifically, the first plating layer 33 contains Ni, and the first embedded portion 31 and the first extended wiring 21 do not contain Ni. Even with the above configuration, electrochemical migration is less likely to occur at the first outer electrode 30.

Preferably, when the element body 10 and the coil 20 are projected onto the second side surface 14 along the axis AX direction of the coil 20, the outer peripheral surface 20a on the inner diameter side of the first curved portion 212 has a curved surface. With the above aspect, the first curved portion 212 includes a smoother surface. When the first curved portion 212 includes a corner portion, the current is likely to concentrate on the corner portion. However, since the first curved portion 212 includes a smooth surface, the current is unlikely to concentrate.

In one aspect, when the element body 10 and the coil 20 are projected onto the second side surface 14 along the axis AX direction of the coil 20, the outer peripheral surface 20a on the inner diameter side of the first curved portion 212 draws a fillet shape from the first coupling portion 211 side of the first curved portion 212 to the first embedded portion 31 and a fillet radius of the fillet shape is equal to or more than 10 μm. The fillet radius is preferably equal to or more than 30 μm, and more preferably equal to or more than 100 μm. The fillet radius is, for example, equal to or less than 300 μm. When the fillet radius is too large, a distance between the first curved portion 212 and the winding portion 23 is reduced. In this case, the first curved portion 212 and the winding portion 23 may come into contact with each other and be short-circuited.

Preferably, when the element body 10 and the coil 20 are projected onto the second side surface 14 along the axis AX direction of the coil 20, the outer peripheral surface 20a on the inner diameter side of the coil 20 in the first curved portion 212 draws a fillet shape. In the present embodiment, in the inductor component 1 having L-shaped electrodes, the fillet shape of the first curved portion 212 is provided on the outer peripheral surface 2a side on the inner diameter side, which can improve adhesiveness between the first curved portion 212 and the first embedded portion 31.

Preferably, the height dimension D1 of the first embedded portion 31 is equal to or less than 20 μm. A lower limit of the height dimension D1 of the first embedded portion 31 is not particularly limited, but is, for example, 10 μm. A value of the height dimension D1 of the first embedded portion 31 is preferably small from the viewpoint of enlarging the coil arrangement area. When the value of the height dimension D1 of the first embedded portion 31 is too small, a current highly concentrates.

Preferably, a height dimension D4 of the first plating layer 33 in a direction parallel to the first height dimension D1 is equal to or less than 10 μm, for example. With the above configuration, the direct current resistance can be reduced, and the Q value is improved. The height dimension D4 of the first plating layer 33 is preferably equal to or less than 8 μm. A lower limit of the height dimension D4 is not particularly limited, but is 1.5 μm, for example. Note that both the height dimension D1 and the height dimension D4 are sizes in the X-axis direction as shown in FIG. 2, and a total of the height dimension D1 and the height dimension D4 is a height dimension of the first embedded portion 31 and the first plating layer 33.

Note that although the first extended wiring 21 and the first outer electrode 30 have been described above, the second extended wiring 22 and the second outer electrode 40 can also have the same or a similar configuration.

### Method for Manufacturing Inductor Component 1

Next, an example of a method for manufacturing the inductor component 1 will be described. Note that the method for manufacturing the inductor component 1 is not limited to the following method, and another manufacturing method may be used.

First, an insulating paste containing borosilicate glass as a main component and an electrically conductive paste containing Ag as a main component are prepared. The insulating paste becomes insulating layers after firing, which will be described later. The electrically conductive paste becomes the coil wiring layers, the extended wirings, the via wirings, and the embedded portions depending on the application positions after firing, which will be described below.

Next, the insulating paste is applied by screen printing to form a portion to be the insulating layer.

A required amount of the electrically conductive paste is applied onto the applied insulating paste by screen printing, and portions to be the coil wiring layer, the extended wiring, and the embedded portions are formed by a patterning process using a photolithography method.

Next, a required amount of the insulating paste is applied by screen printing onto the insulating paste on which the electrically conductive paste has been applied and patterned. Further, an opening is provided at the insulating paste by a patterning process using a photolithography method.

Next, a required amount of the electrically conductive paste is applied by screen printing onto the insulating paste provided with the opening. At this time, the opening is filled with the electrically conductive paste, thereby forming portions to be the via wiring and the embedded portions. In addition, as in the above, portions to be the coil wiring layers, the extended wirings, and the embedded portions are formed by a patterning process using a photolithography method.

Next, an unfired multilayer body is fired under predetermined conditions, the coil wiring layers, the extended wirings, the via wirings, and the embedded portions are obtained from the electrically conductive paste, and the insulating layers are obtained from the insulating paste.

Further, barrel processing is performed on the element body, and then, Ni plating having a thickness of 2 μm to 10 μm and Sn plating having a thickness of 2 μm to 10 μm are formed by barrel plating on portions where the embedded portions are exposed from the element body, to provide the plating layers. The inductor component 1 is completed through the above process.

Note that in the above description, the unfired multilayer body is fired, but instead, a mother multilayer body may be fired after the through holes are provided in the mother multilayer body, and then the through holes may be filled with a magnetic paste to form internal magnetic members. In this case, after the filling of the magnetic paste, the mother multilayer body is cut into multilayer bodies by dicing or the like. In this case, internal magnetic members and external magnetic members can be formed by thermally curing the magnetic paste.

### Second Embodiment

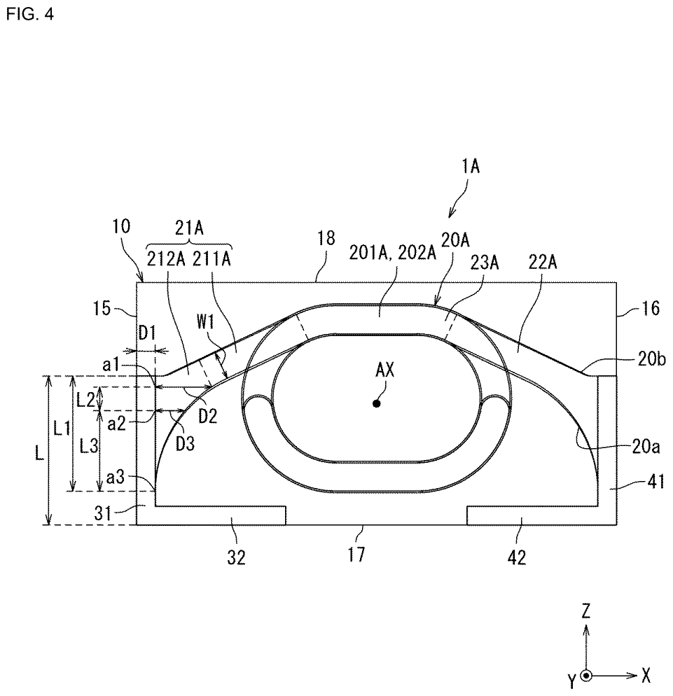

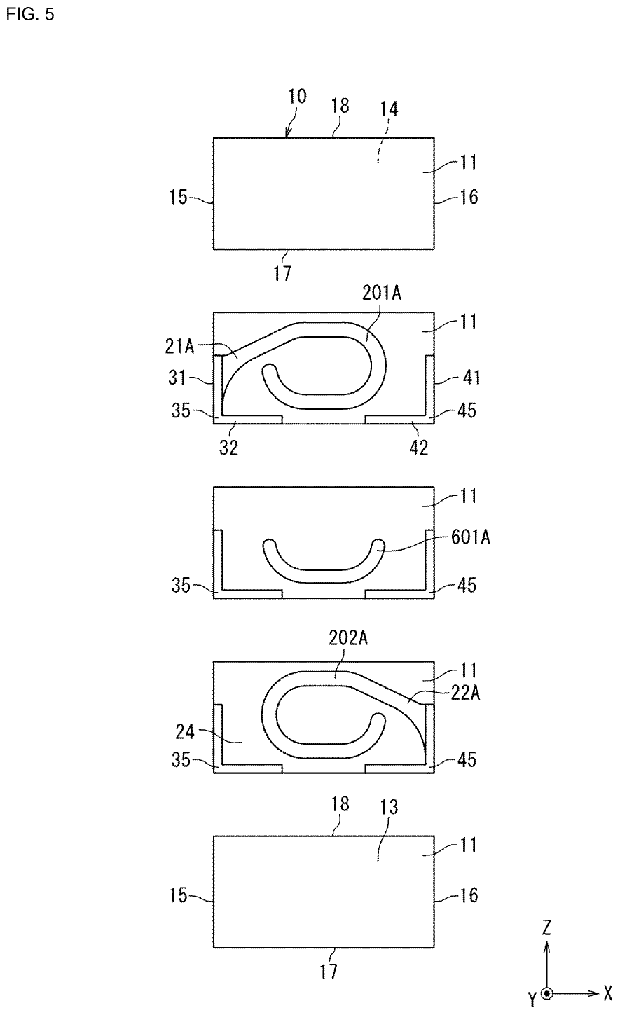

FIG. 4 is a perspective front view of an inductor component 1A of a second embodiment as viewed from the first side surface side. FIG. 5 is an exploded view of the inductor component 1A of the second embodiment. The inductor component 1A is different from the inductor component 1 of the first embodiment in a shape of the coil 20. This difference will be described below. The other configurations are the same as those of the first embodiment, and the same reference signs as those of the first embodiment are given and description thereof will be omitted.

A coil 20A includes a winding portion 23A, a first extended wiring 21A positioned between a first end of the winding portion 23A and the first outer electrode 30, and a second extended wiring 22A positioned between a second end of the winding portion 23A and the second outer electrode 40. Note that the plating layers are not shown in FIG. 4 and FIG. 5. The coil 20A is formed of a material the same as or similar to that of the coil 20.

The winding portion 23A is formed in an elliptical shape when viewed from the axis AX direction. Since the winding portion 23A has the elliptical shape, a firing residual stress is less likely to occur, and current concentration is less likely to occur. Note that the winding portion 23A may have a shape other than the elliptical shape.

The winding portion 23A includes a plurality of coil wiring layers 201A and 202A each of which is wound along a plane, and a longitudinal via wiring 601A coupling the plurality of coil wiring layers 201A and 202A. Coupling the coil wiring layers with the longitudinal via wiring interposed therebetween allows the coil 20A to be more stably formed. Note that the number of coil wiring layers and the number of via wirings are not limited to the above. In addition, the via wiring may have a shape other than the longitudinal via wiring, and may have a circular shape or a quadrangular shape. An end portion of the coil wiring layer coupled to the via wiring having a circular shape constitutes a circular pad portion, and a diameter of the circular pad portion is larger than a line width of an intermediate portion of the coil wiring layer. Further, a via wiring having a different shape may be provided.

### Third Embodiment

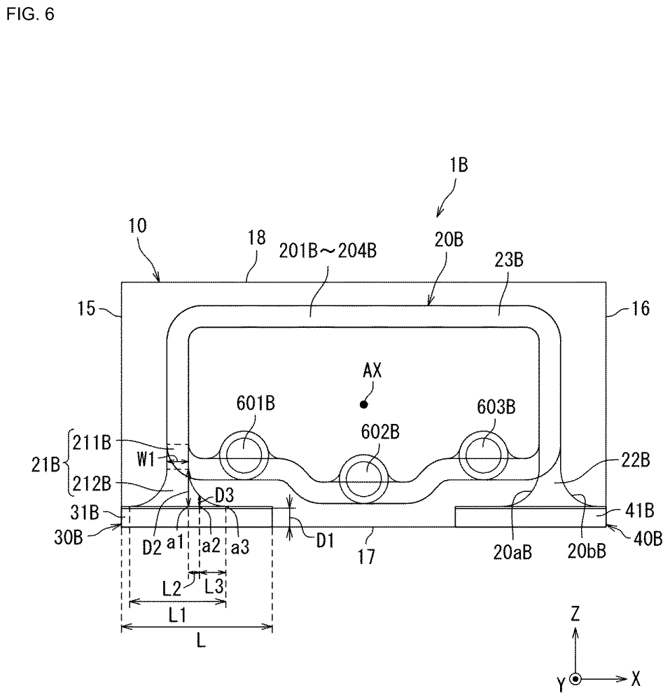

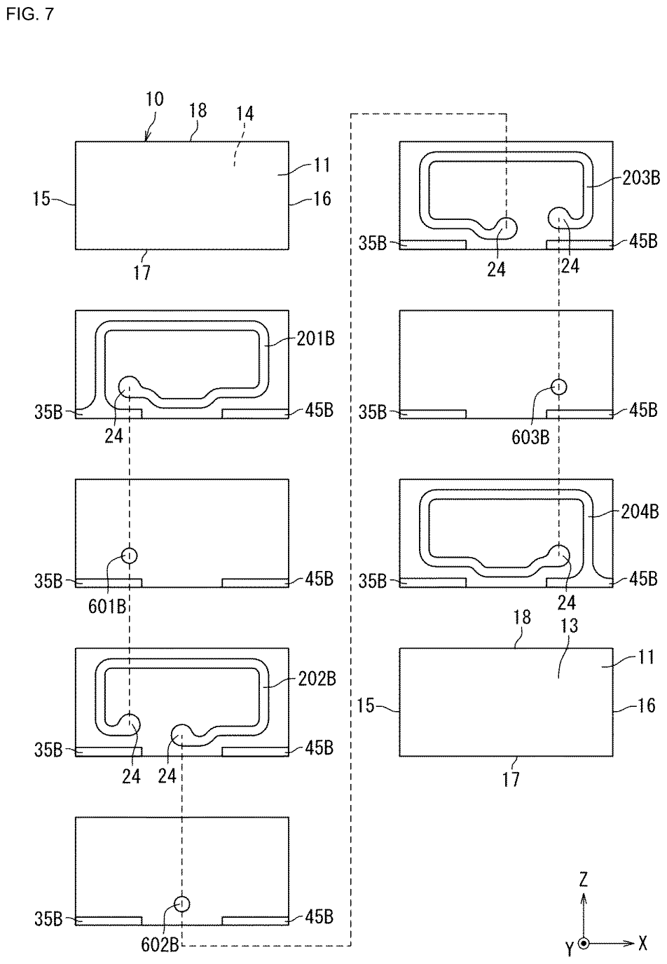

FIG. 6 is a perspective front view of an inductor component 1B of a third embodiment as viewed from the first side surface side. FIG. 7 is an exploded view of the inductor component 1B of the third embodiment. The inductor component 1B is different from the inductor component 1 of the first embodiment in outer electrodes 30B and 40B and a coil 20B. This difference will be described below. The other configurations are the same as those of the first embodiment, and the same reference signs as those of the first embodiment are given and description thereof will be omitted.

As shown in FIG. 6 and FIG. 7, the inductor component 1B includes the element body 10, the coil 20B provided in the element body 10, and the first and second outer electrodes 30B and 40B that are provided at the element body 10 and that are electrically coupled to the coil 20B. The coil 20B includes a winding portion 23B, a first extended wiring 21B coupled between a first end of the winding portion 23B and the first outer electrode 30B, and a second extended wiring 22B coupled between a second end of the winding portion 23B and the second outer electrode 40B. The coil 20B is formed to have a configuration the same as or similar to that of the coil 20. Note that the plating layers are not shown in FIG. 6 and FIG. 7.

The first outer electrode 30B is a bottom electrode provided at the bottom surface 17 and includes a first embedded portion 31B and a plating layer formed on a surface of the first embedded portion 31B. The second outer electrode 40B is a bottom electrode provided at the bottom surface 17 and includes a first embedded portion 41B and a plating layer formed on a surface of the first embedded portion 41B. With the above configuration, a stray capacitance between the outer electrode and the coil is reduced, and thus, radio frequency characteristics are improved. Note that the first outer electrode 30B has a configuration in which a plurality of first outer electrode conductor layers 35B embedded in the element body 10 are laminated in surface contact with each other, and the second outer electrode 40B has a configuration in which a plurality of second outer electrode conductor layers 45B embedded in the element body 10 are laminated in surface contact with each other. The first outer electrode 30B and the second outer electrode 40B are formed of a material the same as or similar to that of the first embodiment.

The coil 20B includes the winding portion 23B, the first extended wiring 21B coupled between a first end of the winding portion 23B and the first outer electrode 30B, and the second extended wiring 22B coupled between a second end of the winding portion 23B and the second outer electrode 40B. The coil 20B is formed of a material the same as or similar to that of the coil 20.

The winding portion 23B includes a plurality of coil wiring layers 201B, 202B, 203B, and 204B each of which is wound along a plane, and via wirings 601B, 602B, and 603B coupling the plurality of coil wiring layers 201B, 202B, 203B, and 204B. Note that the number of coil wiring layers and the number of via wirings are not limited to the above.

The first to fourth coil wiring layers 201B, 202B, 203B, and 204B are made of a material the same as or similar to that of the coil wiring layers of the first embodiment and are provided in a manner the same as or similar to that in the first embodiment.

The first to third via wirings 601B, 602B, and 603B are provided closer to the bottom surface 17 side relative to the axis AX. Unlike the first embodiment, in the third embodiment, the first to third via wirings 601B, 602B, and 603B are not provided at the corner portions of the coil wiring layers. When the first embedded portion 31B and the first embedded portion 41B are provided, the via wirings 601B, 602B, and 603B are not provided at the corner portions of the coil wiring layers, which increases distances from the end surfaces of the element body 10. Thus, a risk of breaking via coupling due to a crack or the like caused by an external force can be reduced.

The pad portions 24 protrude more inward from the coil 20B relative to the first to fourth coil wiring layers 201B, 202B, 203B, and 204B when viewed from the axis AX direction. As shown in FIG. 6, the pad portions 24 do not protrude outward from the coil 20B relative to a respective one of the first to fourth coil wiring layers 201B, 202B, 203B, and 204B, when viewed from the axis AX direction, and each of the pad portions 24 and the respective one of the first to fourth coil wiring layers 201B, 202B, 203B, and 204B are substantially flush with each other at an outer tip end of the coil 20B. With the above configuration, an increase in stray capacitance between the via wirings 601B, 602B, and 603B and the first outer electrode 30B and the second outer electrode 40B can be suppressed.

The first extended wiring 21B is coupled to the first coil wiring layer 201B at one end portion thereof and is coupled to the first outer electrode 30B at the other end portion thereof. The first extended wiring 21B includes a first coupling portion 211B coupled to the winding portion 23B and a first curved portion 212B including a curved surface curved from the first coupling portion 211B toward the first embedded portion 31B side. The curved surface of the first curved portion 212B has a recessed shape, and the length dimension L1 of a first contact surface of the first curved portion 212B between the first embedded portion 31B and the first extended wiring 21 is larger than the wiring width W1 of the first coupling portion 211. In projection onto the second side surface 14 along the axis AX, the length dimension L1 is larger than the height dimension D1 of the first embedded portion 31 in the direction perpendicular to the first contact surface. Note that in the present embodiment, the length dimension refers to the maximum value of a dimension, in the lateral direction (X direction), of a first bonding surface between the first embedded portion 31B and the first curved portion 212B.

The second extended wiring 22B is coupled to the fourth coil wiring layer 204B at one end portion thereof and is coupled to the second outer electrode 40B at the other end portion thereof. The second extended wiring 22B includes a coupling portion coupled to the winding portion 23B and a curved portion including a curved surface curved from the coupling portion toward the first embedded portion side. The curved surface of the curved portion has a recessed shape, and the length dimension L1 of a contact surface of the curved portion between the first embedded portion 41B and the extended wiring is larger than the wiring width W1 of the coupling portion.

Preferably, the surface of the first curved portion 212B is smoothly curved. That is, the first curved portion 212B does not have a corner portion. By having the curved shape, a corner portion where current concentration occurs is not provided, and thus, a Q value for radio frequency can be obtained.

Preferably, in projection onto the second side surface 14 along the axis AX direction, the maximum height dimension D2 of the first curved portion 212B is larger than the height dimension D1 of the first embedded portion 31B. With the above configuration, a surface area of the first extended wiring 21B increases, and heat can be further dissipated at the first extended wiring 21B.

Preferably, in the cross section orthogonal to the first end surface 15 and the top surface 18, an increase rate in wiring width of the first curved portion 212B increases from the contact surface between the first coupling portion 211B and the first curved portion 212B toward the contact surface between the first embedded portion 31B and the first curved portion 212B. That is, the wiring width of the first curved portion 212B is larger than the wiring width W1 of the first coupling portion 211B, and the first curved portion 212B has the largest length dimension L1 at the first contact surface between the first curved portion 212B and the first embedded portion 31B. With the above configuration, an area of the first contact surface between the first curved portion 212B and the first embedded portion 31B is increased, and an amount of a current flowing per unit area can be reduced. Note that the increase rate means that an increase amount in wiring width per unit length along an extending direction of the first curved portion 212B increases as the first curved portion 212B is closer to the first embedded portion 31B.

Preferably, the length dimension L1 of the first contact surface between the first curved portion 212B and the first embedded portion 31B is equal to or more than 10 μm. With the above configuration, the area of the first contact surface is increased, which allows an amount of a current flowing per unit area to be reduced. Further, the first curved portion 212B has a large surface area, and heat generated at the first curved portion 212B can be dissipated. An upper limit of the length dimension L1 is not particularly limited, but is 80 μm when the length dimension L of the first embedded portion 31 is 121 μm, for example. Additionally, the upper limit of the length dimension L1 is not particularly limited, but is, for example, equal to or less than ⅔ of the length dimension L of the first embedded portion 31 (that is, L1/L).

Preferably, in projection onto the second side surface 14 along the axis AX direction, a ratio of the length dimension L1 of the first contact surface relative to the length dimension L of the first embedded portion 31B is equal to or more than 1/8 and equal to or less than 2/3 (i.e., from 1/8 to 2/3). Setting the above-described ratio to be equal to or more than 1/8 increases the area of the first contact surface, resulting in reducing an amount of a current flowing per unit area. Setting the above-described ratio to be equal to or less than 2/3 appropriately keeps a distance between the winding portion 23B and the first curved portion 212B, which can suppress a stray capacitance. In addition, the first curved portion 212B and the winding portion 23B can be isolated from each other, and the risk of a short circuit between the first curved portion 212B and the winding portion 23B can be reduced. Furthermore, a residual stress can be appropriately suppressed, and the occurrence of cracks between the first embedded portion 31B and the first curved portion 212B can be suppressed. When the above-described ratio is too small, the risk of breaking coupling due to electrochemical migration increases. When the above-described ratio is too large, a distance between the winding portion 23B and the first extended wiring 21B is small, which increases the stray capacitance. In addition, the first curved portion 212B and the winding portion 23B are close to each other, and thus, the risk of a short circuit increases. Further, since the residual stress increases, the risk of cracking increases.

Preferably, at least one of the first outer electrode 30B and the second outer electrode 40B further includes a first plating layer (not shown) partially covering at least a portion of the first embedded portion 31B exposed at the surface of the element body 10, and the first plating layer contains metal atoms different from those of the first embedded portion 31B and the first extended wiring 21B. To be specific, the first plating layer contains Ni, and the first embedded portion 31B and the first extended wiring 21B do not contain Ni. Even with the above configuration, electrochemical migration is less likely to occur at the first outer electrode 30B.

Preferably, when the element body 10 and the coil 20B are projected onto the second side surface 14 along the axis AX direction of the coil 20B, an outer peripheral surface 20aB on an inner diameter side of the first curved portion 212B has a curved surface. With the above configuration, the first curved portion 212B includes a smoother surface. When the first curved portion 212B includes a corner portion, a current is likely to concentrate on the corner portion. However, providing the smoother surface causes the current concentration to be less likely to occur.

In one aspect, when the element body 10 and the coil 20B are projected onto the second side surface 14 along the axis AX direction of the coil 20B, the outer peripheral surface 20aB on the inner diameter side of the first curved portion 212B draws a fillet shape from the first coupling portion 211B side of the first curved portion 212B to the first embedded portion 31B and a fillet radius of the fillet shape is equal to or more than 10 μm. The fillet radius is preferably equal to or more than 30 μm, and more preferably equal to or more than 100 μm. The fillet radius is, for example, equal to or less than 300 μm. When the fillet radius is too large, a distance between the first curved portion 212B and the winding portion 23B is reduced. In this case, the first curved portion 212B and the winding portion 23B may contact each other and be short-circuited.

Preferably, a height dimension of the first plating layer in a direction parallel to the height dimension D1 is equal to or less than 10 μm, for example. With the above configuration, a direct current resistance can be reduced, and a Q value is improved. The height dimension of the first plating layer is preferably equal to or less than 8 μm. A lower limit of the height dimension of the first plating layer is not particularly limited, but is, for example, 1.5 μm.

Preferably, the coil 20B includes the outer peripheral surface 20aB on the inner diameter side and an outer peripheral surface 20bB on an outer diameter side opposite to the inner diameter side, and when the element body 10 and the coil 20B are projected onto the second side surface 14 along the axis AX direction of the coil 20B, both the outer peripheral surface 20aB on the inner diameter side and the outer peripheral surface 20bB on the outer peripheral side of the first curved portion 212B include curved surfaces. With the above configuration, the first curved portion 212B includes a smoother surface. When the first curved portion 212B includes a corner portion, a current is likely to concentrate on the corner portion. However, providing the smoother surface causes the current concentration to be less likely to occur. Note that only the outer peripheral surface 20aB on the inner diameter side may include a curved surface, and only the outer peripheral surface 20bB on the outer diameter side may include a curved surface. Further, the outer peripheral surface 20aB on the inner diameter side and the outer peripheral surface 20bB on the outer diameter side may include curved surfaces having different shapes from each other.

Preferably, the coil 20B includes the outer peripheral surface 20aB on the inner diameter side and the outer peripheral surface 20bB on the outer diameter side opposite to the inner diameter side, and when the element body 10 and the coil 20B are projected onto the second side surface 14 along the axis AX direction of the coil 20B, each of the outer peripheral surface 20aB on the inner diameter side and the outer peripheral surface 20bB on the outer diameter side of the first curved portion 212B draws a fillet shape. In the present embodiment, in the inductor component 1B including the bottom electrodes, the fillet shapes are provided on the outer peripheral surface 20aA side on the inner diameter side and the outer peripheral surface 20aB side on the outer diameter side, and thus adhesiveness between the first curved portion 212B and the first embedded portion 31B can be improved.

Note that although the first extended wiring 21B and the first outer electrode 30B have been described above, the second extended wiring 22B and the second outer electrode 40B can also have the same or similar configuration.

### Fourth Embodiment

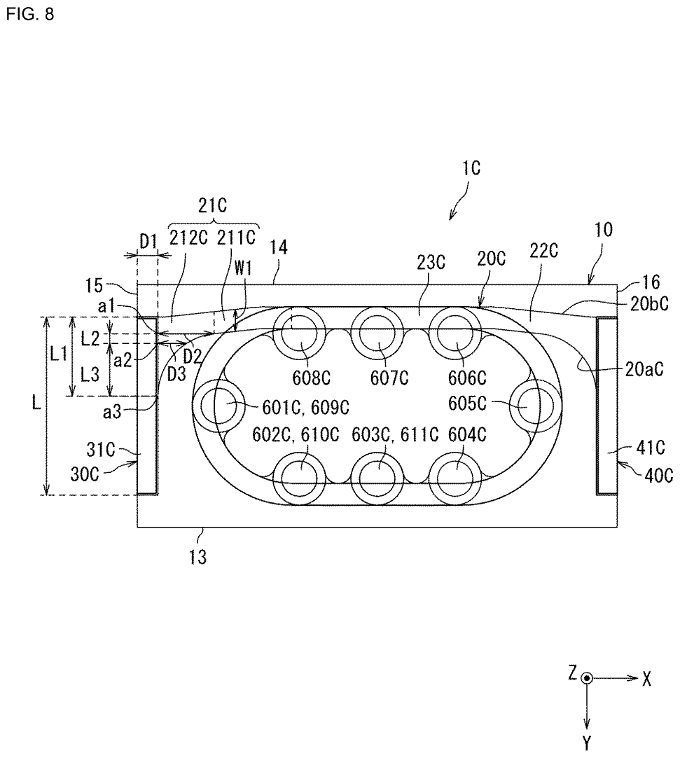

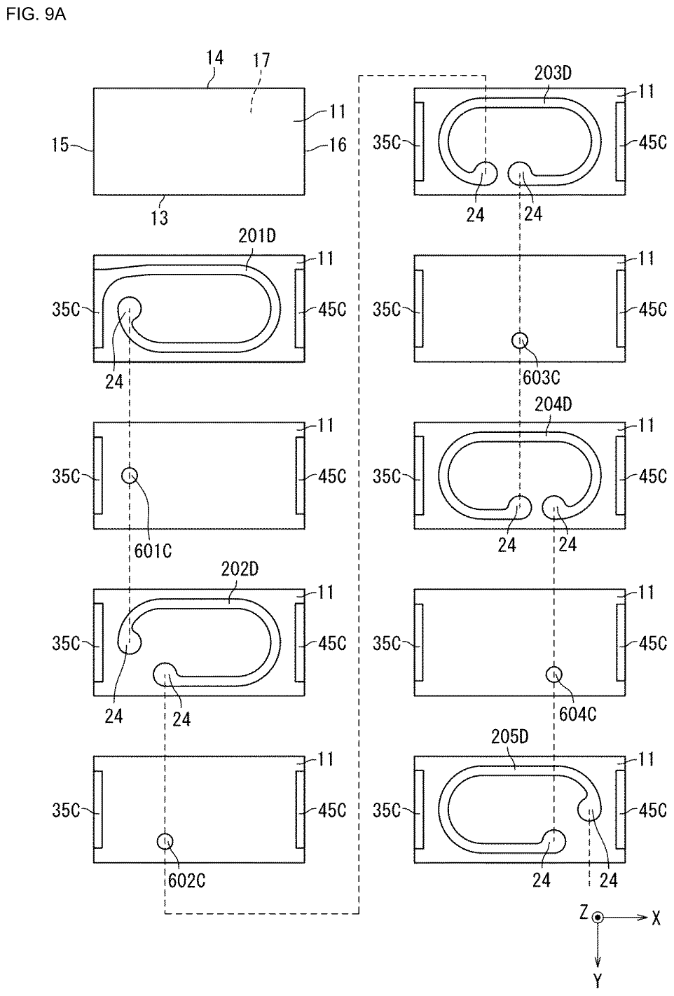

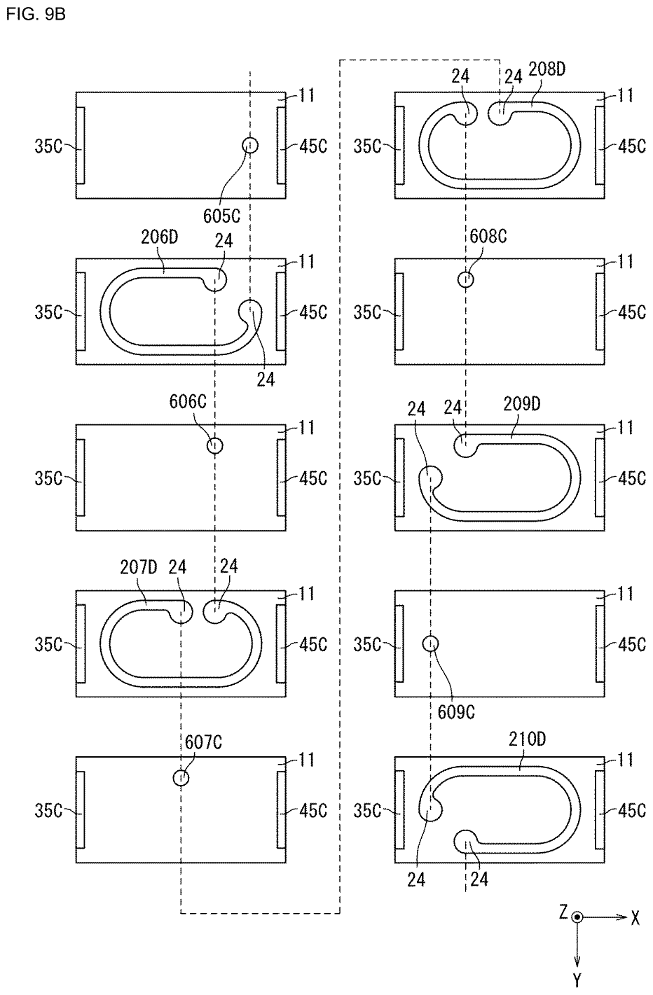

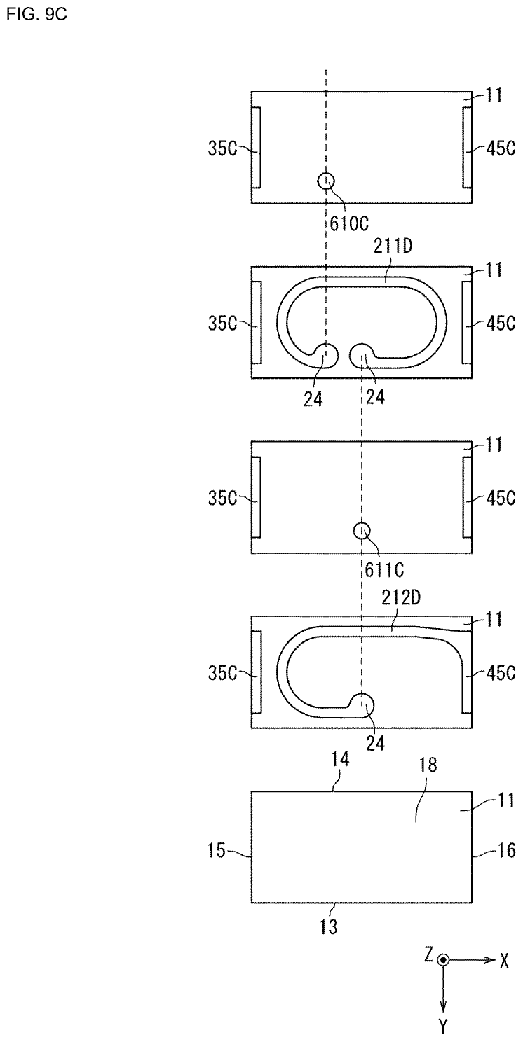

FIG. 8 is a perspective front view of an inductor component 1C of a fourth embodiment as viewed from the top surface side. FIG. 9A to FIG. 9C are exploded views of the inductor component 1C of the fourth embodiment. The dotted line at the lower right of FIG. 9A and the dotted line at the upper left of FIG. 9B are coupled, and the dotted line at the lower right of FIG. 9B and the dotted line at the top of FIG. 9C are coupled. In the first embodiment, the axis of the coil is provided in the direction perpendicular to the first side surface 13 and the second side surface 14, but in the present embodiment, the axis of the coil is provided in a direction perpendicular to the top surface and the bottom surface. Further, the first outer electrode 30 and the second outer electrode 40 are L-shaped electrodes in the first embodiment, but are end surface electrodes provided on the first end surface 15 and the second end surface 16, respectively, in the fourth embodiment. This difference will be described below. The other configurations are the same as those of the first embodiment, and the same reference signs as those of the first embodiment are given and description thereof will be omitted.

As shown in FIG. 8 to FIG. 9C, the inductor component 1C includes the element body 10, a coil 20C provided in the element body 10, and a first outer electrode 30C and a second outer electrode 40C that are provided at the element body 10 and that are electrically coupled to the coil 20C.

The first outer electrode 30C is an end surface electrode provided at the first end surface 15. The first outer electrode 30C includes a first embedded portion 31C provided in the element body and extending along the first end surface 15 and a first plating layer positioned on the surface of the element body 10 and formed on a surface of the first embedded portion 31C. The second outer electrode 40C is an end surface electrode provided at the second end surface 16. The second outer electrode 40C includes a first embedded portion 41C provided in the element body and extending along the second end surface 16 and a first plating layer positioned on the surface of the element body 10 and formed on a surface of the first embedded portion 41C. With the above configuration, an influence of magnetic coupling between adjacent components is reduced, and the degree of freedom in designing arrangement of components is increased. The first and second outer electrodes 30C and 40C are formed of a material the same as or similar to that of the outer electrodes of the first embodiment. Note that the first and second outer electrodes 30C and 40C may have other forms. In addition, FIG. 8, FIG. 9A, FIG. 9B, and FIG. 9C do not show the plating layer.

As shown in FIGS. 9A, 9B, and 9C, the first embedded portion 31C has a configuration in which a plurality of first outer electrode conductor layers 35C embedded in the element body 10 are laminated in surface contact with each other. The first embedded portion 41C has a configuration in which a plurality of second outer electrode conductor layers 45C embedded in the element body 10 are laminated in surface contact with each other. The first outer electrode conductor layer 35C extends along the first end surface 15, and the second outer electrode conductor layer 45C extends along the second end surface 16.

The coil 20C includes a winding portion 23C, a first extended wiring 21C coupled between a first end of the winding portion 23C and the first outer electrode 30C, and a second extended wiring 22C coupled between a second end of the winding portion 23C and the second outer electrode 40C. The coil 20C is formed to have a configuration the same as or similar to that of the coil 20.

As shown in FIG. 8, FIG. 9A, FIG. 9B, and FIG. 9C, the winding portion 23C is parallel to the first end surface 15 and is spirally wound along an axis AX1 direction crossing the top surface 18 and the bottom surface 17. That is, the axis AX1 is orthogonal to the top surface 18 and the bottom surface 17.

The winding portion 23C includes a plurality of coil wiring layers 201D, 202D, 203D, 204D, 205D, 206D, 207D, 208D, 209D, 210D, 211D, and 212D each of which is wound along a plane and via wirings 601C, 602C, 603C, 604C, 605C, 606C, 607C, 608C, 609C, 610C, and 611C coupling the plurality of coil wiring layers. Note that the number of coil wiring layers and the number of via wirings are not limited to the above.

The first to twelfth coil wiring layers 201D, 202D, 203D, 204D, 205D, 206D, 207D, 208D, 209D, 210D, 211D, and 212D are individually sandwiched between the insulating layers 11 and are sequentially laminated along the axis AX1 direction (Z direction). The first to twelfth coil wiring layers 201D, 202D, 203D, 204D, 205D, 206D, 207D, 208D, 209D, 210D, 211D, and 212D are made of a material the same as or similar to that of the coil wiring layers of the first embodiment.

The first to eleventh via wirings 601C, 602C, 603C, 604C, 605C, 606C, 607C, 608C, 609C, 610C, and 611C penetrate the insulating layers 11 in the height direction (Z direction). The coil wiring layers adjacent to each other in the laminating direction are electrically coupled in series through the via wiring. To be specific, the first coil wiring layer 201D and the second coil wiring layer 202D are electrically coupled to each other with the first via wiring 601C interposed therebetween. The second coil wiring layer 202D and the third coil wiring layer 203D are electrically coupled to each other with the second via wiring 602C interposed therebetween. The third coil wiring layer 203D and the fourth coil wiring layer 204D are electrically coupled to each other through the third via wiring 603C interposed therebetween. The fourth coil wiring layer 204D and the fifth coil wiring layer 205D are electrically coupled to each other with the fourth via wiring 604C interposed therebetween. The fifth coil wiring layer 205D and the sixth coil wiring layer 206D are electrically coupled to each other with the fifth via wiring 605C interposed therebetween. The sixth coil wiring layer 206D and the seventh coil wiring layer 207D are electrically coupled to each other with the sixth via wiring 606C interposed therebetween. The seventh coil wiring layer 207D and the eighth coil wiring layer 208D are electrically coupled to each other with the seventh via wiring 607C interposed therebetween. The eighth coil wiring layer 208D and the ninth coil wiring layer 209D are electrically coupled to each other with the eighth via wiring 608C interposed therebetween. The ninth coil wiring layer 209D and the tenth coil wiring layer 210D are electrically coupled to each other with the ninth via wiring 609C interposed therebetween. The tenth coil wiring layer 210D and the eleventh coil wiring layer 211D are electrically coupled to each other with the tenth via wiring 610C interposed therebetween. The eleventh coil wiring layer 211D and the twelfth coil wiring layer 212D are electrically coupled to each other with the eleventh via wiring 611C interposed therebetween.

The first to eleventh via wirings 601C, 602C, 603C, 604C, 605C, 606C, 607C, 608C, 609C, 610C, and 611C are made of a material the same as or similar to that of the coil wiring layers of the first embodiment.

The first extended wiring 21C is coupled to the first coil wiring layer 201D at one end portion thereof and is coupled to the first outer electrode 30C at the other end portion thereof. The first extended wiring 21C includes a first coupling portion 211C coupled to the winding portion 23C and a first curved portion 212C including a curved surface curved from the first coupling portion 211C toward the first embedded portion 31C side. The curved surface of the first curved portion 212C has a recessed shape, and the length dimension L1 of the first contact surface of the first curved portion 212C between the first embedded portion 31C and the first extended wiring 21C is larger than the wiring width W1 of the first coupling portion 211C. In projection onto the bottom surface 17 along the axis AX1, the length dimension L1 is larger than the height dimension D1 of the first embedded portion 31C in the direction perpendicular to the first contact surface. Note that in the present embodiment, the length dimension refers to a dimension from the second side surface 14 to the first side surface 13. That is, the length dimension refers to a size in the Y-axis direction. The height dimension is a dimension from the first end surface 15 toward the second end surface 16. That is, the height dimension refers to a size in the X-axis direction.

The second extended wiring 22C is coupled to the twelfth coil wiring layer 212D at one end portion thereof and is coupled to the second outer electrode 40C at the other end portion thereof. The second extended wiring 22C includes a coupling portion coupled to the winding portion 23C and a curved portion including a curved surface curved from the coupling portion toward the first embedded portion side. The curved surface of the curved portion has a recessed shape, and the length dimension L1 of a contact surface of the curved portion between the first embedded portion 41C and the extended wiring is larger than the wiring width W1 of the coupling portion.

Preferably, the surface of the first curved portion 212C is smoothly curved. That is, the first curved portion 212C does not have a corner portion. By having the curved shape, a corner portion where current concentration occurs is not provided, and thus, a Q value for radio frequency can be obtained.

Preferably, in projection onto the bottom surface 17 along the axis AX1 direction, the maximum height dimension D2 of the first curved portion 212C is larger than the height dimension D1 of the first embedded portion 31C. With the above configuration, the surface area of the first extended wiring 21C increases, and heat can be further dissipated at the first extended wiring 21C.

Preferably, in projection onto the bottom surface 17 along the axis AX1 direction, an increase rate in wiring width of the first curved portion 212C increases from the contact surface between the first coupling portion 211C and the first curved portion 212C toward the contact surface between the first embedded portion 31C and the first curved portion 212C. That is, the wiring width of the first curved portion 212C is larger than the wiring width W1 of the first coupling portion 211C, and the first curved portion 212C has the largest length dimension L1 at the first contact surface between the first curved portion 212C and the first embedded portion 31C. With the above configuration, the first contact surface between the first curved portion 212C and the first embedded portion 31C is increased in area, and an amount of a current flowing per unit area can be reduced. Note that the increase rate means that an increase amount in wiring width per unit length along the extending direction of the first curved portion 212C increases as the first curved portion 212C is closer to the first embedded portion 31C.

Preferably, the length dimension L1 of the first contact surface between the first curved portion 212C and the first embedded portion 31C is equal to or more than 10 μm. With the above configuration, the area of the first contact surface is increased, which allows an amount of a current flowing per unit area to be reduced. Further, the first curved portion 212C has a large surface area, and heat generated at the first curved portion 212C can be dissipated. An upper limit of the length dimension L1 is not particularly limited, but may be 70 μm, for example. Additionally, the upper limit of the length dimension L1 is not particularly limited, and may be, for example, equal to or less than ½ of the length dimension L of the first embedded portion 31.

Preferably, in projection onto the bottom surface 17 along the axis AX direction, a ratio of the length dimension L1 of the first contact surface relative to the length dimension L of the first embedded portion 31C is equal to or more than 1/8 and equal to or less than 2/3 (i.e., from 1/8 to 2/3). Setting the above-described ratio to be equal to or more than 1/8 increases the area of the first contact surface, resulting in reducing an amount of a current flowing per unit area. When the above-described ratio is equal to or less than 2/3, a distance between the winding portion 23C and the first curved portion 212C can be appropriately maintained, and a stray capacitance can be suppressed. In addition, the first curved portion 212C and the winding portion 23C can be isolated from each other, and the risk of a short circuit between the first curved portion 212C and the winding portion 23C can be reduced. Further, a residual stress can be appropriately suppressed, and the occurrence of cracks between the first embedded portion 31C and the first curved portion 212C can be suppressed. When the above-described ratio is too small, the risk of breaking coupling due to electrochemical migration increases. When the above-described ratio is too large, a distance between the winding portion 23C and the first extended wiring 21C is small, and the stray capacitance increases. In addition, the first curved portion 212C and the winding portion 23C are close to each other, and thus, the risk of a short circuit increases. Further, since a residual stress increases, the risk of cracking increases.

Preferably, at least one of the first outer electrode 30C and the second outer electrode 40C further includes a first plating layer (not shown) at least partially covering a portion of the first embedded portion 31C exposed at the surface of the element body 10, and the first plating layer contains metal atoms different from those of the first embedded portion 31C and the first extended wiring 21C. To be specific, the first plating layer contains Ni, and the first embedded portion 31C and the first extended wiring 21C do not contain Ni. Even with the above configuration, electrochemical migration is less likely to occur at the first outer electrode 30C.

Preferably, when the element body 10 and the coil 20C are projected onto the bottom surface 17 along the axis AX1 direction, an outer peripheral surface 20aC on the inner diameter side of the first curved portion 212C includes a curved surface. With the above configuration, the first curved portion 212C includes a smoother surface. When the first curved portion 212C includes a corner portion, a current is likely to concentrate on the corner portion. However, providing the smoother surface causes the current concentration to be less likely to occur.

In one aspect, when the element body 10 and the coil 20C are projected onto the bottom surface 17 along the axis AX1 direction, the outer peripheral surface 20aC on the inner diameter side of the first curved portion 212C draws a fillet shape from the first coupling portion 211C side of the first curved portion 212C to the first embedded portion 31C, and a fillet radius of the fillet shape is equal to or more than 10 μm. The fillet radius is preferably equal to or more than 30 μm, and more preferably equal to or more than 100 μm. The fillet radius is, for example, equal to or less than 300 μm. When the fillet radius is too large, a distance between the first curved portion 212C and the winding portion 23C is reduced, and the first curved portion 212C and the winding portion 23C may contact each other and be short-circuited.

Preferably, a height dimension of the first plating layer in a direction parallel to the height dimension D1 is equal to or less than 10 μm, for example. With the above configuration, a direct current resistance can be reduced, and a Q value is improved. The height dimension of the first plating layer is preferably equal to or less than 8 μm. A lower limit of the height dimension of the first plating layer is not particularly limited, but is, for example, 1.5 μm.

Preferably, the coil 20C includes the outer peripheral surface 20aC on the inner diameter side and an outer peripheral surface 20bC on an outer diameter side opposite to the inner diameter side, and when the element body 10 and the coil 20C are projected onto the bottom surface 17 along the axis AX1 direction, each of the outer peripheral surface 20aC on the inner diameter side and the outer peripheral surface 20bC on the outer diameter side of the first curved portion 212C includes a curved surface. With the above configuration, the first curved portion 212C includes a smoother surface. When the first curved portion 212C includes a corner portion, a current is likely to concentrate on the corner portion. However, providing the smoother surface causes the current concentration to be less likely to occur. Note that only the outer peripheral surface 20aC on the inner diameter side may include a curved surface, and only the outer peripheral surface 20bC on the outer diameter side may include a curved surface. Furthermore, the outer peripheral surface 20aC on the inner diameter side and the outer peripheral surface 20bC on the outer diameter side may include curved surfaces having different shapes from each other.

Preferably, the coil 20C includes the outer peripheral surface 20aC on the inner diameter side and the outer peripheral surface 20bC on the outer peripheral side opposite to the inner peripheral side, and when the element body 10 and the coil 20C are projected onto the bottom surface 17 along the axis AX1 direction, each of the outer peripheral surface 20aC on the inner diameter side and the outer peripheral surface 20bC on the outer diameter side of the first curved portion 212C draws a fillet shape. In the present embodiment, in the inductor component 1C including the end surface electrodes, the fillet shapes are provided on the outer peripheral surface 20aC side on the inner diameter side and the outer peripheral surface 20bC side on the outer diameter side, which can improve adhesiveness between the first curved portion 212C and the first embedded portion 31C.

Although the first extended wiring 21C and the first outer electrode 30C have been described above, the second extended wiring 22C and the second outer electrode 40C can also have the same or a similar configuration.

### Method for Manufacturing Inductor Component 1C

Next, an example of a method for manufacturing the inductor component 1C will be described. Note that the method for manufacturing the inductor component 1C is not limited to the following method, and another manufacturing method may be used.

The method for manufacturing the inductor component 1C can be performed in a manner the same as or similar to the method for manufacturing the inductor component 1. However, in the inductor component 1C, the laminating direction of the insulating paste is the Z-axis direction.

Note that the present disclosure is not limited to the above-described embodiments, and design changes can be made without departing from the scope of the present disclosure. For example, the features of the first to fourth embodiments may be combined in various ways.

The present disclosure includes the following aspects.
<1> An inductor component comprising an element body; a coil provided in the element body; and a first outer electrode and a second outer electrode that are provided at the element body and that are electrically coupled to the coil. The coil includes a winding portion spirally wound along an axis direction. The coil includes the winding portion, and a first extended wiring and a second extended wiring that couple one end and the other end of the winding portion to the first outer electrode and the second outer electrode, respectively. At least one of the first outer electrode and the second outer electrode includes an embedded portion embedded in the element body. At least one of the first extended wiring and the second extended wiring includes a coupling portion coupled to the winding portion and a curved portion curved from the coupling portion toward the embedded portion. Also, in projection along the axis direction, the curved portion has a recessed shape, and a length dimension L1 of a contact surface between the embedded portion and the extended wiring is larger than a wiring width W1 of the coupling portion, and the length dimension L1 is larger than a height dimension D1 of the embedded portion in a direction perpendicular to the contact surface.
<2> The inductor component according to <1>, wherein in projection along the axis direction, the curved portion has a maximum height dimension D2 in a direction parallel to the height dimension D1 of the embedded portion, and the maximum height dimension D2 is larger than the height dimension D1.
<3> The inductor component according to <2>, wherein an increase rate in a wiring width of the curved portion increases from a contact surface between the coupling portion and the curved portion toward a contact surface between the embedded portion and the curved portion.
<4> The inductor component according to <2> or <3>, wherein in production along the axis direction, a first contact point a1 having the maximum height dimension D2, a second contact point a2 having a height dimension D3 that is half of the maximum height dimension D2, and a third contact point a3 at which a surface of the curved portion is in contact with the embedded portion are arranged in this order on a contact surface between the embedded portion and the curved portion. Also, a length dimension L3 along the contact surface between the embedded portion and the curved portion from the second contact point a2 to the third contact point a3 is larger than a length dimension L2 along the contact surface between the embedded portion and the curved portion from the first contact point a1 to the second contact point a2.
<5> The inductor component according to any one of <1> to <4>, wherein the length dimension L1 is equal to or more than 10 μm.
<6> The inductor component according to any one of <1> to <5>, wherein in projection along the axis direction, a ratio of the length dimension L1 of a portion facing a contact surface between the embedded portion and the curved portion relative to a length dimension L of a portion of the embedded portion exposed at a surface of the element body is equal to or more than 1/8 and equal to or less than 2/3 (i.e., from 1/8 to 2/3).
<7> The inductor component according to any one of <1> to <6>, wherein at least one of the first outer electrode and the second outer electrode further includes a plating layer at least partially covering a portion of the embedded portion exposed at a surface of the element body, the plating layer includes Ni, and the first extended wiring and the embedded portion do not include Ni.
<8> The inductor component according to any one of <1> to <7>, wherein the coil includes an outer peripheral surface on an inner diameter side and an outer peripheral surface on an outer diameter side opposite to the inner diameter side. Also, in projection along the axis direction, at least one of the outer peripheral surface on the inner diameter side of the curved portion and the outer peripheral surface on the outer diameter side of the curved portion draws a fillet shape, and a fillet radius of the fillet shape is equal to or more than 10 μm.
<9> The inductor component according to any one of <1> to <8>, wherein the height dimension D1 of the embedded portion is equal to or less than 20 μm.
<10> The inductor component according to any one of <1> to <9>, wherein a height dimension D4 of the plating layer in a direction parallel to the height dimension D1 is equal to or less than 10 μm.
<11> The inductor component according to any one of <1> to <10>, wherein the element body includes a first end surface and a second end surface that are opposed to each other, a first side surface and a second side surface that are opposed to each other, a bottom surface coupled between the first end surface and the second end surface and between the first side surface and the second side surface, and a top surface opposed to the bottom surface. Also, the axis is orthogonal to the first side surface and the second side surface, the first outer electrode is continuously formed from the first end surface to the bottom surface, and the second outer electrode is continuously formed from the second end surface to the bottom surface.
<12> The inductor component according to <11>, wherein the coil includes an outer peripheral surface on an inner diameter side and an outer peripheral surface on an outer diameter side opposite to the inner diameter side, and in projection along the axis direction, an outer peripheral surface of the curved portion on the inner diameter side draws a fillet shape.
<13> The inductor component according to any one of <1> to <10>, wherein the element body includes a first end surface and a second end surface that are opposed to each other, a first side surface and a second side surface that are opposed to each other, a bottom surface coupled between the first end surface and the second end surface and between the first side surface and the second side surface, and a top surface opposed to the bottom surface. Also, the axis is orthogonal to the first side surface and the second side surface, and the first outer electrode and the second outer electrode are provided at the bottom surface.
<14> The inductor component according to <13>, wherein the coil includes an outer peripheral surface on an inner diameter side and an outer peripheral surface on an outer diameter side opposite to the inner diameter side. Also, in projection along the axis direction, each of an outer peripheral surface of the curved portion on the inner diameter side and an outer peripheral surface of the curved portion on the outer diameter side draws a fillet shape.
<15> The inductor component according to any one of <1> to <10>, wherein the element body includes a first end surface and a second end surface that are opposed to each other, a first side surface and a second side surface that are opposed to each other, a bottom surface coupled between the first end surface and the second end surface and between the first side surface and the second side surface, and a top surface opposed to the bottom surface. Also, the axis is orthogonal to the bottom surface and the top surface, the first outer electrode is provided on the first end surface, and the second outer electrode is provided on the second end surface.

What is claimed is:

1. An inductor component comprising:
an element body;
a coil in the element body and including a winding portion helically wound along an axis direction;
a first outer electrode and a second outer electrode that are at the element body and that are electrically connected to the coil,
wherein,
the coil includes a first extended wiring and a second extended wiring that connect one end and the other end of the winding portion to the first outer electrode and the second outer electrode, respectively,
at least one of the first outer electrode and the second outer electrode includes an embedded portion embedded in the element body,
at least one of the first extended wiring and the second extended wiring includes a coupling portion coupled to the winding portion and a curved portion curved from the coupling portion toward the embedded portion, and
in a projection view along the axis direction,
the curved portion has a recessed shape, and a length dimension of a contact surface between the embedded portion and the extended wiring is larger than a wiring width of the coupling portion, and
the length dimension is larger than a height dimension of the embedded portion in a direction perpendicular to the contact surface.

2. The inductor component according to claim 1, wherein
in the projection view along the axis direction, the curved portion has a maximum height dimension in a direction parallel to the height dimension of the embedded portion, and the maximum height dimension is larger than the height dimension.

3. The inductor component according to claim 2, wherein
an increase rate in a wiring width of the curved portion increases from a contact surface between the coupling portion and the curved portion toward a contact surface between the embedded portion and the curved portion.

4. The inductor component according to claim 2, wherein
in a view along the axis direction, a first contact point having the maximum height dimension, a second contact point having a height dimension that is half of the maximum height dimension, and a third contact point at which a surface of the curved portion is in contact with the embedded portion are arranged in this order on a contact surface between the embedded portion and the curved portion, and
a length dimension along the contact surface between the embedded portion and the curved portion from the second contact point to the third contact point is larger than a length dimension along the contact surface between the embedded portion and the curved portion from the first contact point to the second contact point.

5. The inductor component according to claim 1, wherein
the length dimension is equal to or more than 10 μm.

6. The inductor component according to claim 1, wherein
in the projection view along the axis direction, a ratio of the length dimension of a portion facing a contact surface between the embedded portion and the curved portion relative to a length dimension of a portion of the embedded portion exposed at a surface of the element body is from 1/8 to 2/3.

7. The inductor component according to claim 1, wherein
at least one of the first outer electrode and the second outer electrode further includes a plating layer at least partially covering a portion of the embedded portion exposed at a surface of the element body, and
the plating layer includes Ni, and
the first extended wiring and the embedded portion do not include Ni.

8. The inductor component according to claim 1, wherein
the coil includes an outer peripheral surface on an inner diameter side and an outer peripheral surface on an outer diameter side opposite to the inner diameter side,
in the projection view along the axis direction, at least one of the outer peripheral surface on the inner diameter side of the curved portion and the outer peripheral surface on the outer diameter side of the curved portion draws a fillet shape, and
a fillet radius of the fillet shape is equal to or more than 10 μm.

9. The inductor component according to claim 1, wherein
the height dimension of the embedded portion is equal to or less than 20 μm.

10. The inductor component according to claim 7, wherein
a height dimension of the plating layer in a direction parallel to the height dimension is equal to or less than 10 μm.

11. The inductor component according to claim 1, wherein
the element body includes a first end surface and a second end surface that are opposed to each other, a first side surface and a second side surface that are opposed to each other, a bottom surface connected between the first end surface and the second end surface and between the first side surface and the second side surface, and a top surface opposed to the bottom surface,
the axis is orthogonal to the first side surface and the second side surface,
the first outer electrode is continuous from the first end surface to the bottom surface, and
the second outer electrode is continuous from the second end surface to the bottom surface.

12. The inductor component according to claim 11, wherein
the coil includes an outer peripheral surface on an inner diameter side and an outer peripheral surface on an outer diameter side opposite to the inner diameter side, and
in the projection view along the axis direction, an outer peripheral surface of the curved portion on the inner diameter side defines a fillet shape.

13. The inductor component according to claim 1, wherein
the element body includes a first end surface and a second end surface that are opposed to each other, a first side surface and a second side surface that are opposed to each other, a bottom surface connected between the first end surface and the second end surface and between the first side surface and the second side surface, and a top surface opposed to the bottom surface,
the axis is orthogonal to the first side surface and the second side surface, and
the first outer electrode and the second outer electrode are at the bottom surface.

14. The inductor component according to claim 13, wherein
the coil includes an outer peripheral surface on an inner diameter side and an outer peripheral surface on an outer diameter side opposite to the inner diameter side, and
in the projection view along the axis direction, each of an outer peripheral surface of the curved portion on the inner diameter side and an outer peripheral surface of the curved portion on the outer diameter side defines a fillet shape.

15. The inductor component according to claim 1, wherein
the element body includes a first end surface and a second end surface that are opposed to each other, a first side surface and a second side surface that are opposed to each other, a bottom surface connected between the first end surface and the second end surface and between the first side surface and the second side surface, and a top surface opposed to the bottom surface,
the axis is orthogonal to the bottom surface and the top surface,
the first outer electrode is on the first end surface, and
the second outer electrode is on the second end surface.

16. The inductor component according to claim 2, wherein
the length dimension is equal to or more than 10 μm.

17. The inductor component according to claim 2, wherein
in the projection view along the axis direction, a ratio of the length dimension of a portion facing a contact surface between the embedded portion and the curved portion relative to a length dimension of a portion of the embedded portion exposed at a surface of the element body is from 1/8 to 2/3.

18. The inductor component according to claim 2, wherein
at least one of the first outer electrode and the second outer electrode further includes a plating layer at least partially covering a portion of the embedded portion exposed at a surface of the element body, and
the plating layer includes Ni, and
the first extended wiring and the embedded portion do not include Ni.

19. The inductor component according to claim 2, wherein
the coil includes an outer peripheral surface on an inner diameter side and an outer peripheral surface on an outer diameter side opposite to the inner diameter side,
in the projection view along the axis direction, at least one of the outer peripheral surface on the inner diameter side of the curved portion and the outer peripheral surface on the outer diameter side of the curved portion draws a fillet shape, and
a fillet radius of the fillet shape is equal to or more than 10 μm.

20. The inductor component according to claim 2, wherein
the height dimension of the embedded portion is equal to or less than 20 μm.
